(19) United States
(12) Patent Application Publication
(10) Pub. No.: US 2008/0210507 A1
(43) Pub. Date: Sep. 4, 2008

(54) Electrical system

(76) Inventor: Drew Arthur Johnson, Pawtucket, RI (US)

Correspondence Address: FAY SHARPE LLP, 1100 SUPERIOR AVENUE, SEVENTH FLOOR, CLEVELAND, OH, 44114, US

(21) Appl. No.: 12/040,667

(22) Filed: Feb. 29, 2008

Related U.S. Application Data
(60) Provisional application No. 60/892,587, filed on Mar. 2, 2007.

(51) Int. Cl. H02G 11/02

(52) U.S. Cl. 191/12.4

(57) ABSTRACT

An electrical system comprises a housing containing a reel for an extension cord. The extension cord has cord station(s) along its length and a terminal outlet at one end. A detachable outlet can be plugged into a cord station, providing an electrical socket at the cord station.

This application claims priority from U.S. Provisional Patent Application Ser. No. 60/892,587, filed Mar. 2, 2007.

### BACKGROUND

This disclosure relates to electrical systems for providing power to electrical equipment. In particular, portable electrical systems which are suitable for outdoor use are disclosed.

Electrical equipment is present in many aspects of everyday life. In particular, it may be desired to use electrical equipment in environments where electrical outlets are either inconvenient or too few in number. For example, a party on the patio may require a small fridge, a blender, equipment to keep food warm, musical equipment, and lighting. This can require the use of multiple extension cords and surge protectors. In addition, cleanup can be inconvenient as well, with the need to spend time untangling the cords, and the resulting unstrung cords can be unsightly. It would be desirable to provide a system that can alleviate these problems.

### SUMMARY OF THE DISCLOSURE

Disclosed, in various embodiments, are electrical systems that are suitable for providing electrical power. The electrical systems comprise an extension cord having a cord station along its length, into which a detachable outlet can be plugged to serve as an electrical outlet.

In some embodiments, a portable electrical system comprises: a housing, a cord reel located inside the housing, an extension cord, and at least one detachable outlet;
the extension cord adapted to be wound around the cord reel and comprising at least one cord station along the length of the extension cord and a terminal outlet at one end of the extension cord;
the terminal outlet comprising at least one socket;
the cord station comprising at least one connection hole and at least one seal per connection hole, the seal adapted to cover the connection hole;
the detachable outlet comprising at least one socket and at least one connector; and
wherein electrical power can be provided to the socket of the detachable outlet when the detachable outlet is connected to the station by placing the connector into the connection hole.

In some embodiments, the detachable outlet further comprises an outlet port and the cord station further comprises a station port, the outlet port and station port being shaped such that the detachable outlet and cord station can be connected in only one operative orientation. The detachable outlet may comprise a total of two sockets; and the station may comprise a total of two connection holes. The electrical system may have a total of two detachable outlets. The detachable outlet may further comprise at least one release button.

The extension cord may have cord stations located at regular intervals along the length of the extension cord. In some embodiments, the extension cord is about 100 feet long and has stations located approximately every 10 feet along the length of the extension cord.

The terminal outlet may further comprise at least one light, such as a light emitting diode. The terminal outlet may further comprise a hook for hanging the terminal outlet. The terminal outlet can also be adapted to pivot relative to the extension cord. The socket of the terminal outlet may be able to swivel.

The portable electrical system may further comprise a door on the rear of the housing. The door can be configured so that a spike can be driven through the door to secure the portable electrical system to the ground.

The front of the housing of the electrical system contains a mouth or opening from which the extension cord protrudes, and may be shaped such that the extension cord has an angle of dispersion of at least 70°.

The housing may further contain a surge protection system, the surge protection system comprising a station in which the detachable outlet can be stored, wherein the detachable outlet then functions as a surge protector.

In other embodiments, a portable electrical system comprises: a housing, a cord reel located inside the housing, an extension cord, and at least one detachable outlet;
the extension cord adapted to be wound around the cord reel and comprising at least one cord station along the length of the extension cord and a terminal outlet at one end of the extension cord;
the terminal outlet comprising two sockets, at least one light emitting diode, and a hook for hanging the terminal outlet;
the cord station comprising two connection holes and two seals, the seals adapted to cover the connection holes;
the detachable outlet comprising two release buttons, two sockets, and two connectors; and
wherein electrical power is provided to the sockets of the detachable outlet when the detachable outlet is connected to the cord station.

In additional embodiments, a detachable outlet for use with a portable electrical system comprises at least one electrical socket and one connector, wherein an electrical current can flow from the connector to the electrical socket.

These and other non-limiting characteristics of the disclosure are more particularly disclosed below.

### DESCRIPTION OF THE FIGURES

The following is a brief description of the drawings, which are presented here for purposes of illustrating various aspects of embodiments of the present disclosure and not to be limiting features thereof.

FIG. 1 is an exploded view of an exemplary embodiment of the electrical system

FIG. 2 is a side view of an exemplary embodiment of the inside of the electrical system.

FIG. 3 is a rear perspective view of an exemplary embodiment of the electrical system.

FIG. 4 is a perspective view of an embodiment of a cord station and a detachable outlet.

FIG. 5 is a bottom view of an embodiment of the detachable outlet.

FIG. 6 is a diagram view of a cord station showing its wiring.

FIG. 7 is a top view of an exemplary embodiment of the terminal outlet of the electrical system.

FIG. 8 is a rear view of an exemplary embodiment of the terminal outlet of the electrical system, showing the pivoting ability of the terminal outlet.

FIG. 9 is a top rear view of one embodiment of the electrical system.

### DETAILED DESCRIPTION

A more complete understanding of the systems, components, and apparatuses disclosed herein can be obtained by reference to the accompanying drawings. These drawings are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity).

The electrical system of the present disclosure is portable. The electrical system comprises a housing, a cord reel located inside the housing, an extension cord, and at least one detachable outlet. In particular, the detachable outlet may be plugged into any one of several cord stations along the extension cord. This provides flexibility in how and where electrical outlets are located and/or used. The extension cord can be wound around the cord reel and comprises at least one cord station along the length of the extension cord and a terminal outlet at one end of the extension cord.

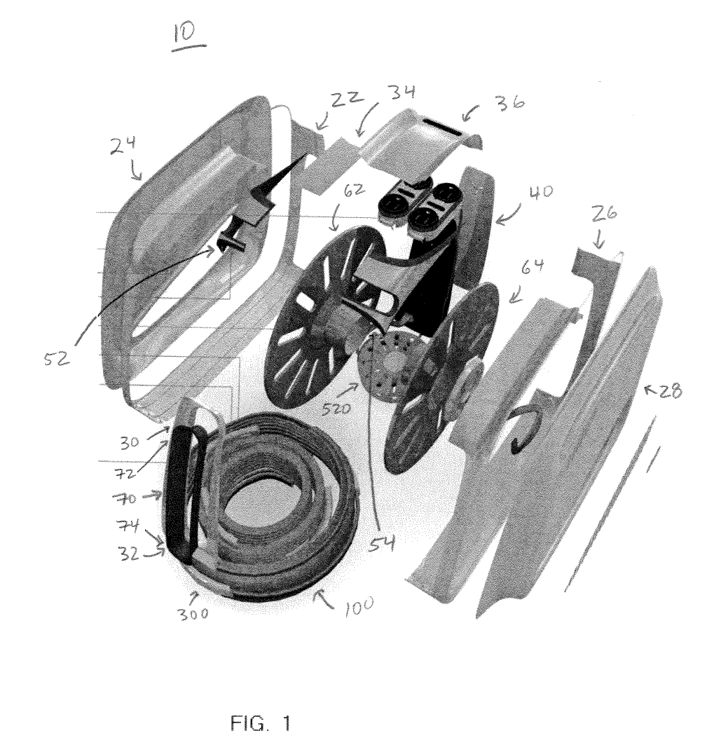

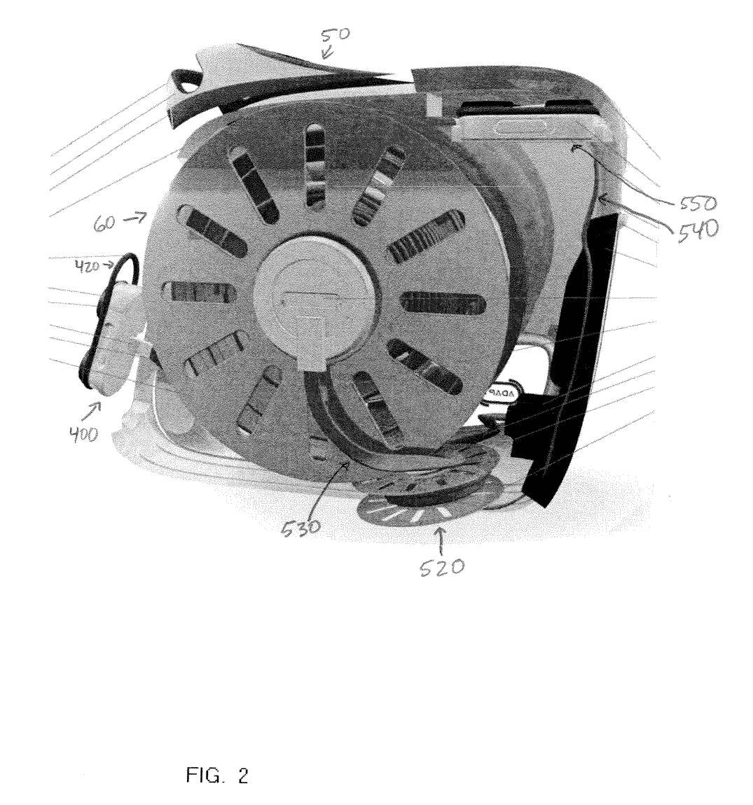

With reference to FIGS. 1-3, the electrical system 10 comprises a housing 20. As shown here, the housing 20 is made from several pieces, including a left frame 22, a left side panel 24, a right frame 26, a right side panel 28, a front panel 30, a body mouth 32, a top panel 34, a storage lid 36, a rear door 40, a left handle piece 52, and a right handle piece 54. As desired, of course, the housing 20 can be made from fewer pieces. The housing is non-conducting. Inside the housing 20 is a cord reel 60. As shown here, the cord reel is made from two pieces, a left reel piece 62 and a right reel piece 64. In specific embodiments, the cord reel has a diameter between about 4.5 and about 12 inches, particularly a diameter of about 10 inches. Wound around the cord reel 60 is an extension cord 100 that comprises at least one cord station 300 along its length and a terminal outlet 400 at one end. (The extension cord is not shown on the cord reel in FIG. 1.) The terminal outlet 400 comprises at least one electrical socket 410 and may include a hook 420, a pivot 430, and an outlet covering cap 440. A plug cord 500 has at one end an electrical plug 510 for providing power to the electrical system. The plug cord 500 is wound around a plug reel 520. From the plug reel 520, electrical power is provided via electrical line 530 to the extension cord 100 using methods known in the art. Another electrical line 540 runs to a surge protector 550 located inside the housing 20. As shown here, the surge protector 550 is near the rear top of the electrical system, beneath the storage lid 36. The electrical system may also include an auto-retracting mechanism (not shown) for the extension cord and/or the plug cord.

The housing 20 generally has a handle 50, which may be located on the top near the front. The housing is generally rectangular. The front of the housing has an opening 70 from which the extension cord protrudes. As shown in FIG. 1, this opening is framed by the body mouth 32. The opening 70 is relatively large and as shown here, of a generally rectangular shape. This allows the extension cord to have a large angle of dispersion (i.e, it does not need to be pulled straight out) so that the coating of the extension cord does not get worn by rubbing along the opening. In embodiments, the extension cord may have an angle of dispersion of at least 60° or at least 70°. The angle of dispersion can be measured as the angle formed by two imaginary lines, one line drawn from the top 72 of the opening 70 to the center of the cord reel and the other line drawn from the bottom 74 of the opening 70 to the center of the cord reel.

The housing may generally be made from any polymeric material that is non-conducting, such as polypropylene or polytetrafluoroethylene. In particular, the body mouth 32 from which the extension cord protrudes may be a non-stick material such as polytetrafluoroethylene; this allows for easier reeling and winding of the extension cord. The cord reel may be made of a stronger material, such as forged aluminum.

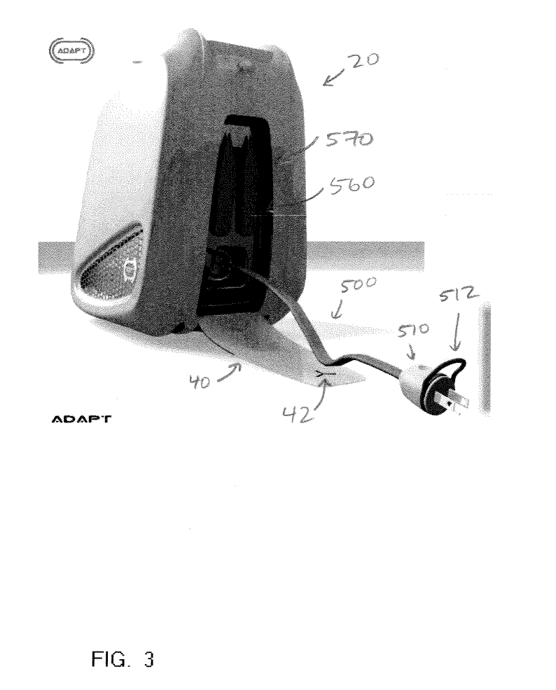

As seen in FIG. 3, a door 40 may be included at the rear of the housing. As shown here, the door 40 is a flip-down door, i.e. opening downwards. This exposes the electrical plug 510, which is plugged into another electrical outlet for providing power to the electrical system. This electrical plug may have, for example, about 15 feet of cord to provide some flexibility. As shown here, the plug 510 includes a hook 512 for easy handling. The flip-down door may also expose a storage area 570 for storing spikes 560, which can be used to anchor the housing to the ground. For example, as shown here, the flip-down door 40 may include a hole 42 through which a spike can be placed to anchor the housing to the ground.

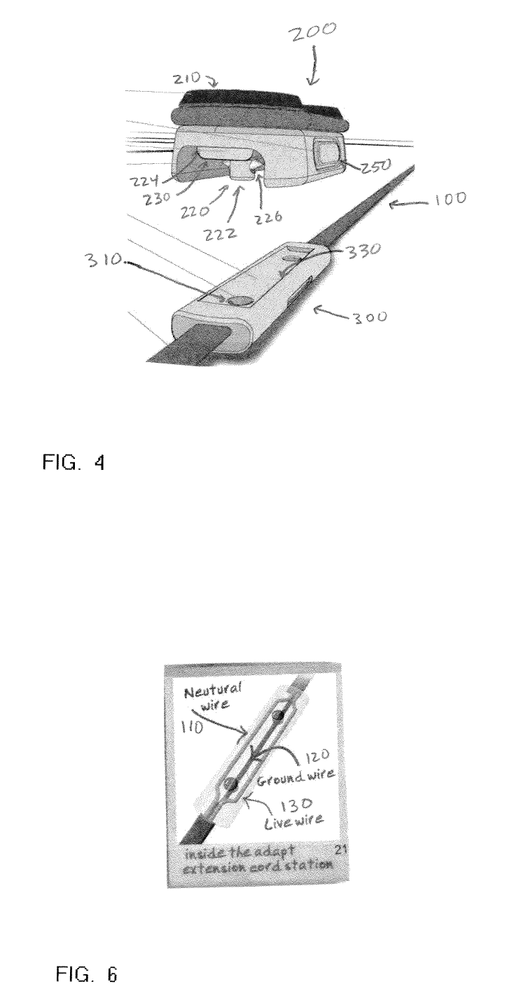

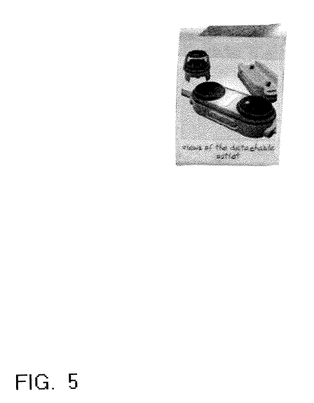

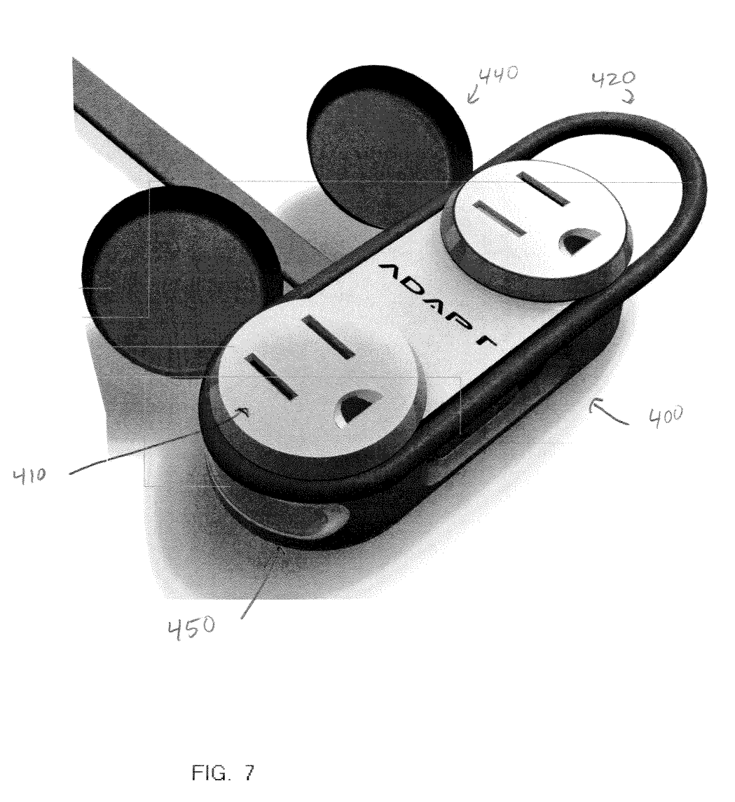

FIGS. 4-6 illustrate, in one embodiment, how a cord station 300 located along the length of the extension cord 100 operates together with a detachable outlet 200 which can be plugged into the cord station to provide power. The extension cord can be any length and have any orientation. In specific embodiments, the extension cord is about 100 feet long and is wound around the cord reel. As seen in FIG. 6, the extension cord 100 contains three wires: a neutral wire 110, a ground wire 120, and a live wire 130. Inside the cord station, the three wires are separated. The extension cord may be made from copper or aluminum conductors with polyvinyl chloride (PVC) material insulation with a rubber coating. The three wires are, for example, stranded 12 gauge copper wire. As shown here, the extension cord 100 has a relatively flat, rectangular cross-section for easy separation of the three wires. However, the extension cord does not need to maintain this rectangular cross-section between cord stations.

The extension cord 100 further comprises at least one cord station 300 along the length of the extension cord. The cord station 300 is usually rectangular, but can be generally of any shape. The cord station 300 further comprises at least one connection hole 310. The connection hole may be cylindrical or any shape compatible with the connector 220 of the detachable outlet 200. A waterproof seal 320 (not seen) can cover each connection hole. The connection hole generally has a small cross-section, e.g. about one-quarter inch. In other words, it is dimensioned such that a child's finger is unable to enter the connection hole. The waterproof seal further covers the connection hole to reduce inadvertent shocks. When a connector 220 attached to the detachable outlet 200 is inserted into the connection hole 310, it contacts the three wires 110, 120, 130 such that electrical power is provided to an electrical socket 210 on the detachable outlet 200. The cord station 300 and detachable outlet 200 may be shaped such that the detachable outlet 200 can only be inserted in one orientation, preventing any chance of a reverse connection, which can be dangerous to the user. For example, the detachable outlet 200 may comprise an outlet port 230 and the cord station 300 may comprise a station port 330, the outlet port 230 and station port 330 being shaped such that they can be connected in only one operative orientation. The extension cord may have any number of cord stations located along the length of the extension cord. The cord stations may be located at regular or irregular intervals. In specific embodiments, the cord stations are located at regular intervals.

The detachable outlet 200 comprises at least one socket 210 and at least one connector 220. Generally, the number of sockets and the number of connectors is equal. The socket(s) may swivel, i.e. move in a circumferential direction, as well; this accommodates devices having large plugs. The detachable outlet also has release button(s) 250 to detach the outlet from the cord station it is plugged into. As shown here, the connector 220 comprises a member 222 extending from a base surface 224 of the detachable outlet 200. The member 222 may have a cylindrical cross-section. Two or three wire contacts 226 extend outwards from the member 222. In embodiments, the wire contacts extend radially from the member 222. The wire contacts are conductive. One wire contact contacts each of the three wires in the cord station. Alternatively, the bottom of the member 222 may serve as a wire contact. Inside the detachable outlet is structure known to those in the art to connect the current provided by the wire contacts to the socket(s) 210. The wire contacts 226 can also be connected to a release button 250 such that when the button is depressed, the wire contact 226 retracts into the member 222.

In specific embodiments, the detachable outlet has two sockets, two connectors, and two release buttons. In specific embodiments, the electrical system has two detachable outlets. However, the electrical system may have any number of detachable outlets. In some embodiments, the detachable outlet 200 may further comprise a light 240 (not shown) located, for example, on the top of the outlet near or between socket(s). The light may simply signal that the outlet has power or it may be used for illumination.

Being able to separate the electrical socket from the extension cord provides at least two advantages. The cord station takes up a smaller volume when the extension cord is wound up on the cord reel compared to the combination of cord station and detachable outlet. This allows the extension cord to have more cord stations along its length than would otherwise be possible if the electrical socket had to also be provided for. This results in greater flexibility for the user, who can decide (i) where along the length of the extension cord a socket is needed and (ii) reduces the volume of cord that must be stored.

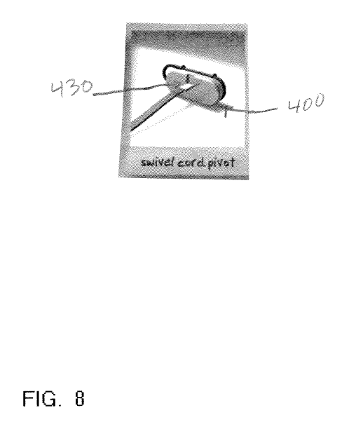

Referring now to FIGS. 7 and 8, the extension cord has a terminal outlet 400 at one end. The terminal outlet 400 can swivel and/or pivot relative to the extension cord 100. The term “pivot” refers to the outlet rotating about an axis. The terminal outlet 400 has at least one socket 410; an outlet having two sockets is shown in FIG. 7. The terminal outlet 400 may further comprise at least one light 450 which is located on a side of the terminal outlet and is used for illumination. The light can be a light emitting diode. The light can also be any color, in particular bright white. The terminal outlet 400 is shaped to have a hook 420 which helps with pulling the cord and hanging the terminal outlet up. The term “hook” refers to a structure which allows the outlet to be hung. As shown here, the hook 420 is in the form of a loop which extends from one side and returns completely to the side. Of course, the hook may also have the conventional shape, where the loop extends from one side and curves back towards the side, but does not return to the side. The hook may be made from rubber or other polymeric material. The terminal outlet 400 may also have covering caps 440 for covering the sockets and reassuring the user that water will not enter the socket and/or shock him. Again, the socket(s) may swivel.

The cord station, detachable outlet, and terminal outlet may also be made from any suitable polymeric material, such as polypropylene. The seals used to make the cord station waterproof may be made from, for example, silicone rubber.

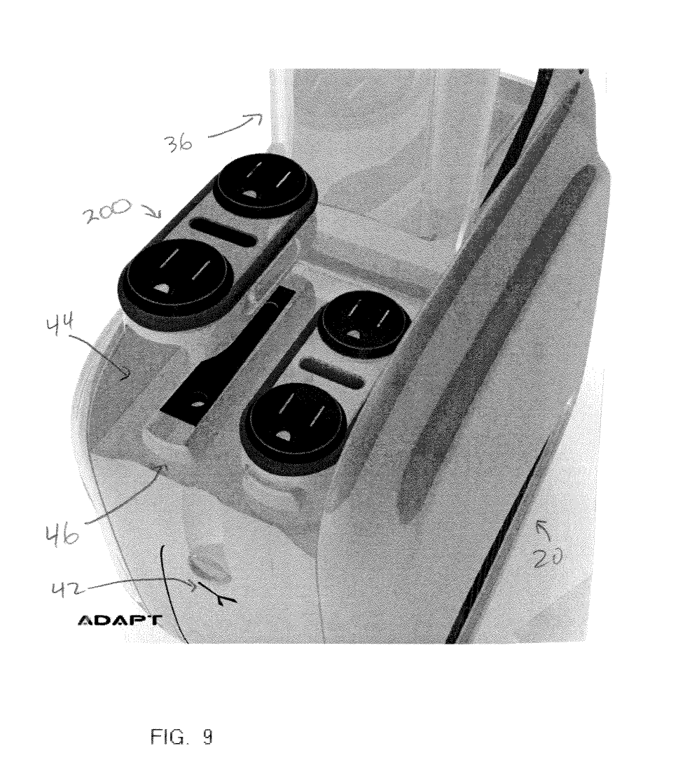

Referring now to FIG. 9, the housing 20 may further comprise a storage section 44 located at the rear and the top of the housing. A storage lid 36 exposes this storage section. The storage section may be used to store the detachable outlet(s).

The electrical system 10 may optionally include a surge protection system 550. Generally, the detachable outlet(s) 200 are stored in a storage section 44 of the housing. When the detachable outlet(s) is plugged into a station 46 located in the storage section 44 and attached to the surge protection system 550, they can serve as a surge-protected outlet.

The electrical system may operate on any voltage. For example, it can run at 110V or 220V.

The systems, components, and apparatuses of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A portable electrical system comprising: a housing, a cord reel located inside the housing, an extension cord, and at least one detachable outlet;
the extension cord adapted to be wound around the cord reel and comprising at least one cord station along the length of the extension cord and a terminal outlet at one end of the extension cord;
the terminal outlet comprising at least one socket;
the cord station comprising at least one connection hole and at least one seal per connection hole, the seal adapted to cover the connection hole;
the detachable outlet comprising at least one socket and at least one connector; and
wherein electrical power can be provided to the socket of the detachable outlet when the detachable outlet is connected to the station by placing the connector into the connection hole.

2. The portable electrical system of claim 1, wherein the detachable outlet further comprises an outlet port and the cord station further comprises a station port; and the outlet port and station port are shaped such that the detachable outlet and cord station can be connected in only one operative orientation.

3. The portable electrical system of claim 1, wherein the detachable outlet comprises a total of two sockets; and the station comprises a total of two connection holes.

4. The portable electrical system of claim 1, comprising a total of two detachable outlets.

5. The portable electrical system of claim 1, wherein the detachable outlet further comprises at least one release button.

6. The portable electrical system of claim 1, wherein the extension cord has cord stations located at regular intervals along the length of the extension cord.

7. The portable electrical system of claim 6, wherein the extension cord is about 100 feet long and has stations located approximately every 10 feet along the length of the extension cord.

8. The portable electrical system of claim 1, wherein the terminal outlet further comprises at least one light.

9. The portable electrical system of claim 8, wherein the light is a light emitting diode.

10. The portable electrical system of claim 1, wherein the terminal outlet further comprises a hook for hanging the terminal outlet.

11. The portable electrical system of claim 1, wherein the terminal outlet is adapted to pivot relative to the extension cord.

12. The portable electrical system of claim 1, wherein the socket of the terminal outlet can swivel.

13. The portable electrical system of claim 1, wherein the housing further comprises a handle.

14. The portable electrical system of claim 1, further comprising an electrical plug for providing power to the portable electrical system.

15. The portable electrical system of claim 1, further comprising a door on the rear of the housing.

16. The potable electrical system of claim 16, further comprising at least one spike, wherein the door is configured so that the spike can be driven through the door to secure the portable electrical system to the ground.

17. The portable electrical system of claim 1, wherein the front of the housing contains an opening from which the extension cord protrudes and the opening is shaped such that the extension cord has an angle of dispersion of at least 70 °.

18. The portable electrical system of claim 1, wherein the housing further contains a surge protection system, the surge protection system comprises a station in which the detachable outlet can be stored, wherein the detachable outlet then functions as a surge protector.

19. A portable electrical system comprising: a housing, a cord reel located inside the housing, an extension cord, and at least one detachable outlet;
the extension cord adapted to be wound around the cord reel and comprising at least one cord station along the length of the extension cord and a terminal outlet at one end of the extension cord;
the terminal outlet comprising two sockets, at least one light emitting diode, and a hook for hanging the terminal outlet;
the cord station comprising two connection holes and two seals, the seals adapted to cover the connection holes;
the detachable outlet comprising two release buttons, two sockets, and two connectors; and
wherein electrical power is provided to the sockets of the detachable outlet when the detachable outlet is connected to the cord station.

20. A detachable outlet for use with a portable electrical system, the detachable outlet comprising at least one electrical socket and one connector, wherein an electrical current can flow from the connector to the electrical socket.
